(19) United States
(12) Patent Application Publication
(10) Pub. No.: US 2005/0123185 A1
(43) Pub. Date: Jun. 9, 2005

(54) Computer aided detection workflow and user interface

(76) Inventors: Ram Balasubramanian, Palo Alto, CA (US); Yang Zheng, San Jose, CA (US)

Correspondence Address: Pamela R. Crocker;Patent Legal Staff, Eastman Kodak Company, 343 State Street, Rochester, NY, 14650-2201, US

(21) Appl. No.: 10/992,042

(22) Filed: Nov. 18, 2004

Related U.S. Application Data
(60) Provisional application No. 60/525,216, filed on Nov. 26, 2003.

(51) Int. Cl. G06K 9/00

(52) U.S. Cl. 382/132; 382/128

(57) ABSTRACT

A method and a system for a workflow and user interfaces for an automated detection system. A user interface method for a computer aided detection system includes a plurality of steps, including: (a) accessing an image case, the image case comprising one or more digital images; (b) identifying a view orientation for each of the one or more digital images; (c) transmitting the image case to an algorithm server for processing of each of the one or more digital images to generate a computer aided detection report for the image case; (d) providing a report system adapted to organize a plurality of computer aided detection reports wherein each of the computer aided detection reports are selectable by an operator for viewing; (e) automatically transmitting the computer aided detection report to the report system; (f) allowing the operator to select the computer aided detection report for viewing; and (g) displaying the selected computer aided detection report on the display.

### CROSS REFERENCE TO RELATED APPLICATIONS

Reference is made to, and priority is claimed from, commonly assigned Provisional Patent Application U.S. Ser. No. 60/525,216 (Kodak Docket No.87432), entitled “WORKFLOW AND USER INTERFACE FOR A COMPUTER AIDED DETECTION APPLICATION”, and filed on Nov. 26, 2003 in the names of Balasubramanian et al, and which is incorporated herein by reference.

### FIELD OF THE INVENTION

The present invention relates to a workflow and user interface of an automated detection application, and in particular, to a system for facilitating the input of films or digital data into a computer aided detection (CAD) algorithm server, and presenting the detection reports to radiologists.

### BACKGROUND OF THE INVENTION

Computer aided detection (CAD) is being employed to assist health/medical practitioners by complementing traditional image diagnosis methods which rely on visual analysis.

CAD analysis of X-ray mammography films or digital images involves the digitization of conventional x-ray films or the import of digital data, and processing of the input digital images with a CAD processing server to produce a CAD report indicating candidate areas of the breast that may exhibit abnormalities.

A well-known type of X-ray mammography exam is a screening exam which is performed on asymptomatic patients. Typically, several mammograms (taken at different viewing angles) are required to provide a set of images covering the entire volume of each breast. One practice in North America is to obtain four views (two views for each breast) which are taken along the cranio-caudal (CC) and medio-lateral oblique (MLO) planes, respectively. However, in particular circumstances, the acquisition of a number of views that differ from the standard four views may be required. Special circumstances may also include examination of symptomatic patients, in which cases the radiologist may request additional view(s) or views along axes that differ from the standard CC and MLO axes.

There exists a need for a workflow and user interface to integrate the use of CAD in the clinical workflow so as to complement traditional image diagnosis methods.

### SUMMARY OF THE INVENTION

An object of the present invention is to provide an integrated workflow and simple user interface technique for a computer aided detection (CAD) application which can be employed in existing clinical environments.

Any objects provided are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

The present invention provides a method for acquiring a set of mammogram images, sending to a CAD application and presenting the results. The method comprises the steps of: digitizing sets of mammogram films organised by a tabbed and coloured separator sheet, or importing an exam of a number of digital mammogram images; automatic image quality control (QC); sending to an algorithm server to process the set of images; then presenting the CAD results in soft-copy or paper-copy format on digital images with user desired layout (hanging protocol). When the application is using in a screening environment, the results can be sequentially accessed with very simple user interaction.

According to one aspect of the present invention there is provided a method and a system for a workflow and user interfaces for an automated detection system. A user interface method for a computer aided detection system includes a plurality of steps, including: (a) accessing an image case, the image case comprising one or more digital images; (b) identifying a view orientation for each of the one or more digital images; (c) transmitting the image case to an algorithm server for processing of each of the one or more digital images to, generate a computer aided detection report for the image case; (d) providing a report system adapted to organize a plurality of computer aided detection reports wherein each of the computer aided detection reports are selectable by an operator for viewing; (e) automatically transmitting the computer aided detection report to the report system; (f) allowing the operator to select the computer aided detection report for viewing; and (g) displaying the selected computer aided detection report on the display.

### BRIEF DESCRIPTION OF THE DRAWINGS

The foregoing and other objects, features, and advantages of the invention will be apparent from the following more particular description of the preferred embodiments of the invention, as illustrated in the accompanying drawings. Further features and advantages of the present invention will become apparent from the following detailed description, taken in combination with the appended drawings, in which:

FIGS. 1 and 2 show diagrams of an embodiment of the system in accordance with the present invention.

FIGS. 3A-3G show an exemplary acquisition user interface in accordance with the present invention.

FIGS. 4A-4B show an exemplary result report user interface.

### DETAILED DESCRIPTION OF THE PREFERRED EMBODIMENT

The following is a detailed description of the preferred embodiments of the invention, reference being made to the drawings in which the same reference numerals identify the same elements of structure in each of the several figures.

The present invention is directed to a method and a system for a workflow and user interfaces for an automated detection system.

In the following description, features of the invention are described by way of an exemplary embodiment that is optimized for mammography screening program. However, it will be understood that the present invention is in no way limited to such embodiment. In fact, the present invention can equally be applied to many other fields in medical imaging.

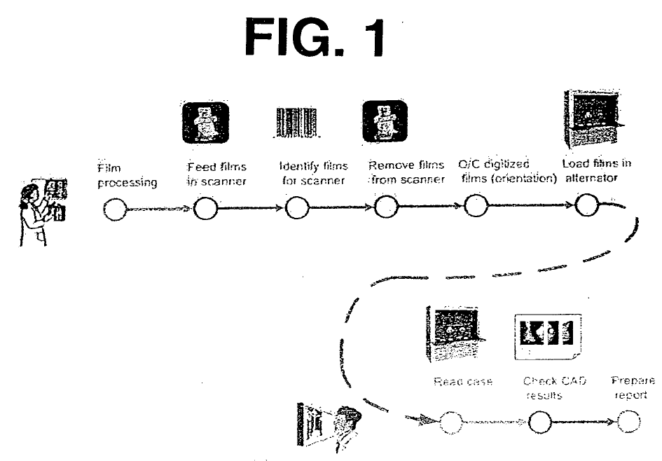

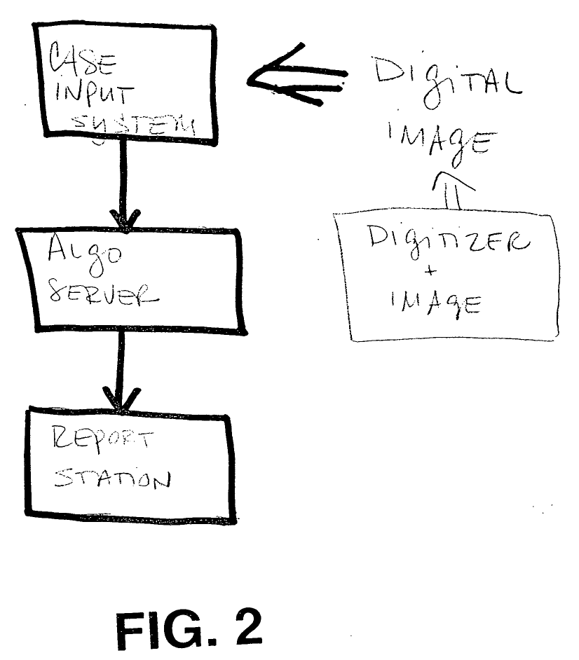

An embodiment of the system used to implement the method of the invention is schematically represented in FIGS. 1 and 2. The system generally comprises a Case Input System (CIS), a CAD algorithm (algorithm server), and a Report Station (RS). The CIS acquires the digitized images, performs quality control, automatically recognises view orientation, extracts label identifications, and sends the digital images (a case) to the algorithm server(s). The CIS can also run routine maintenance for the system (including the digitizer), provide a history log, and be linked to a data repository to store the acquired digital images.

Images belonging to the same patient and acquired as part of a prescribed examination can be grouped together to form a case. A case may comprise one or several film images. A separator sheet is typically used to separate cases placed on the digitizer. The CIS automatically detects the separator sheet and organizes the films between two separator sheets as a case. The separator sheets are colored and tabbed to allow easy identification by the user. They also have unique patterns printed on them that are recognized by the CIS. A unique identifier such as a serial number can also be included on the separator sheet. The tabs are located in different locations along the top of the separator sheet to allow the user to see how many cases are stacked together. Cases are identified by a bar code. The CIS uses existing or off-the-shelf barcodes to identify each case to their digital images. The barcode allows the case to be tracked throughout the CAD process and easily identified at the RS. If no any barcode is available, a number pad is provided to enter an identification code, or an internal identification code is automatically generated for each case.

Once the barcode is read for each case, the films can be stacked in any order. The cases are then separated by separator sheets and stacked on the digitizer. Once stacked the cases will be automatically queued and scanned.

After each case is scanned, the orientation (side and view) of each film is automatically determined and shown to the user for verification. Patient labels are extracted from the films and displayed to the user. If the case passes quality control it is automatically sent to the algorithm server(s); otherwise, the user has the option to manually override quality control and send the case to the algorithm server(s).

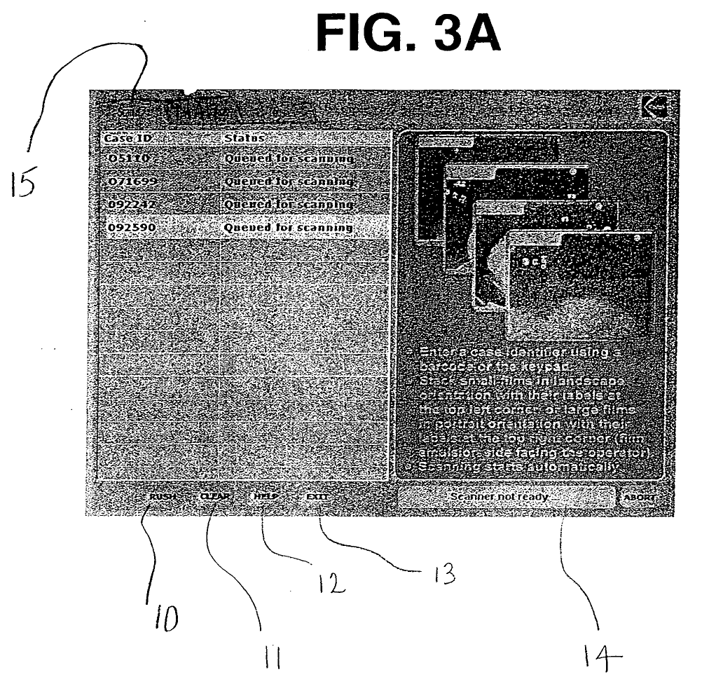

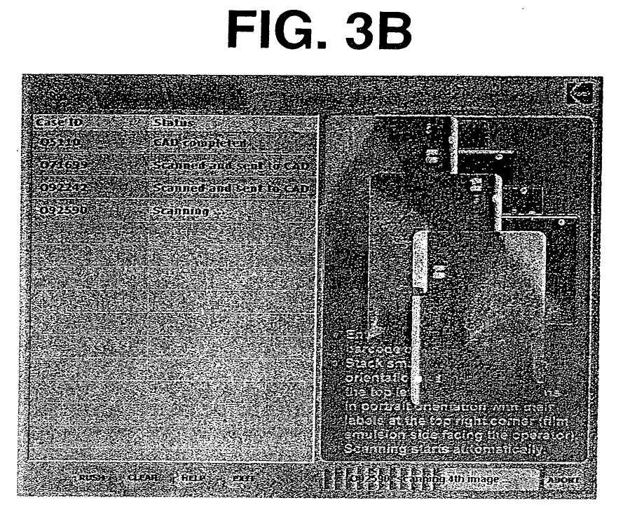

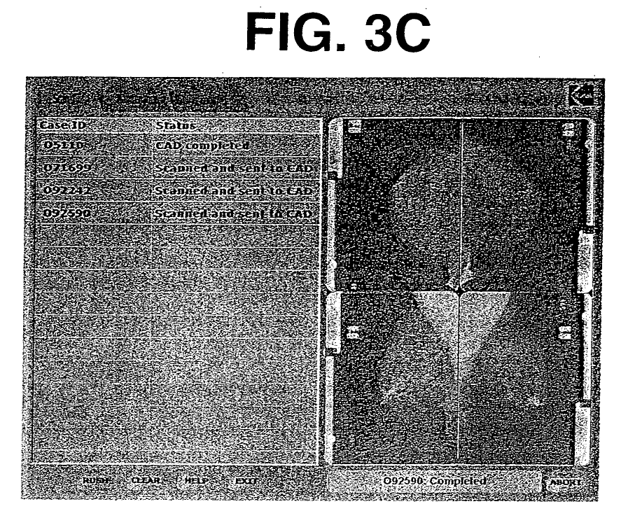

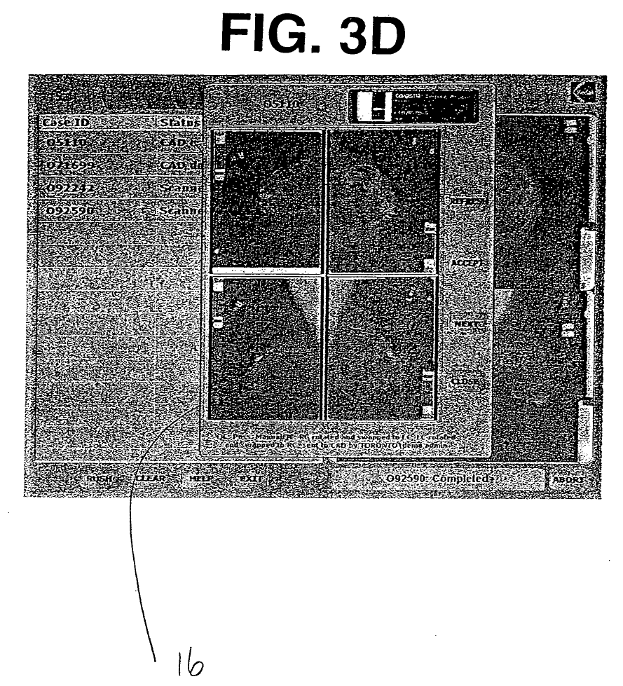

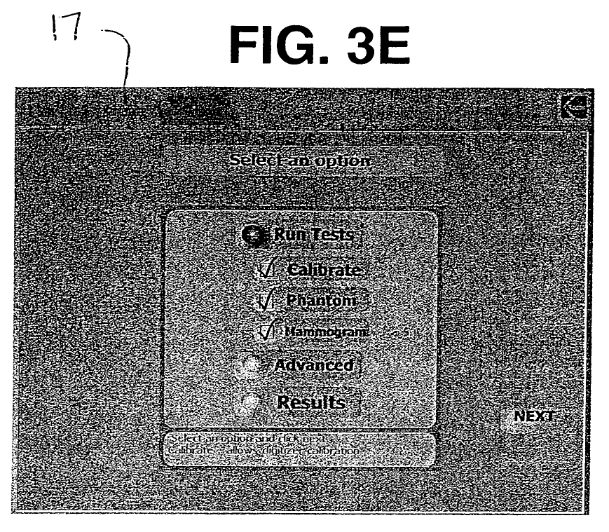

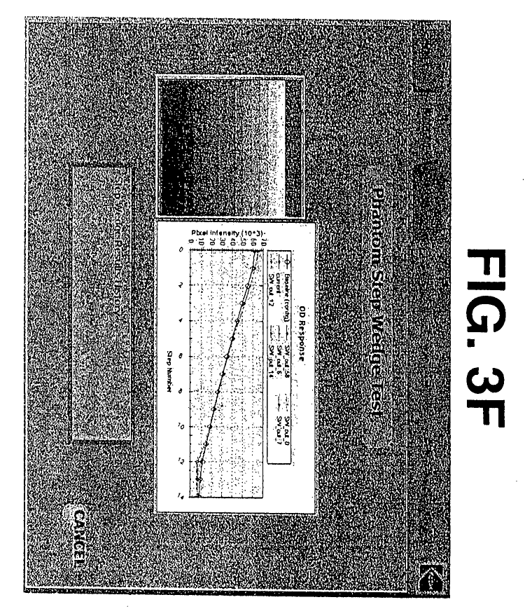

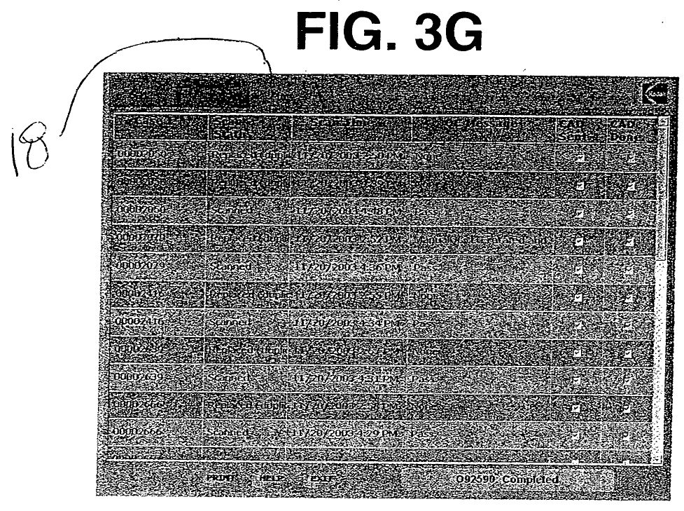

FIGS. 3A-3G illustrate a user interface of the Case Input Station (CIS) in accordance with the present invention. More particularly, FIGS. 3A-3G show an exemplary display screen of a display for the CIS.

Referring to FIG. 3A, in a scanning screen, the user can view the scanning queue, which is filled by the bar code or manual key entry. The scanning queue is visually displayed and, once a case is scanned, its digital images can be viewed by selecting it, for example by clicking on it (if using a mouse-type device) or touching the screen (if using a touchscreen display). The queue also allows cases to be inserted and immediately scanned by using a “rush” button/member 10. Other members allow further operation, for example, “clear” 11, “help” 12, and “exit” 13. A display area 14 can provide information on the status of the operation.

A tab/marker 15 notated as “Scan”, located at the top of the screen in FIG. 3A, is an indication to the user that the user is operating within the scanning portion of the user interface.

As shown in FIG. 3B, as a case is being scanned, the image is rotated and displayed in a “stacked” mode, which is shown in FIG. 3B on the right side window of the screen. The digital images are stacked in the same order that they are scanned. This mode shows the progress of the images as they are scanned in a progress bar on the bottom of the screen.

Once the case is complete, all images are resorted and reoriented before being displayed (shown in FIG. 3C), before the view is cleared to make room for the next case. The completed case can be viewed by selecting/clicking on its name in the queue.

Moving now to FIG. 3D, a pop up window 16 shows the case, with the final orientation classification. As shown in FIG. 3D, the pop up window (also sometimes referred to as a balloon window) overlaps the information already shown on the screen. The pop up window can provide the user information about the image qc (quality control) and status (for example, whether or not the case has been sent to the algorithm server).

The queue view (shown on the left side of the main screen) shows the case identifier (shown as a bar code number in FIG. 3D) in the left column and several status types in the right column. When the case is initially input, the status is shown as “Queued”. Then, once the case has begun scanning, the status is shown as “Scanning”. Once the scanning is complete, the status is shown as “Scanned”. After the case is scanned, the status will also indicate that the case has been sent to CAD, or has not (and preferably indicate why). For example, if the case fails QC (quality control), the status will reflect this.

Other features of the CIS can include (1) a large pictured instruction for staging films on digitizer, (2) touch sensitive help pop up windows, (3) a real-time display of the digitized film and scan status, (4) a case in the queue can be removed, (5) a case can be aborted while digitizing, and (6) the number of images in a case is configurable.

The CIS can include a Maintenance feature, as shown in the displayed screen of FIG. 2E. A tab/marker 17 notated as “Maintenance”, located at the top of the screen in FIG. 3E, is an indication to the user that the user is operating within the maintenance portion of the user interface.

This Maintenance feature would allows the user to perform some general system maintenance, including, but not limited to, quality control of the digitizer. The screen enables the user to perform maintenance through a “wizard” style, although other embodiments are possible and would be known to those skilled in the art.

Using this screen, the user is able to select which (if any) tests to run. The user can be prompted to run certain tests depending on a variety of factors, including, but not limited to, the time span since the last test.

The tests can include the ability to manually calibrate the digitizer. The digitizer response can also be tested with a phantom film (e.g., step wedge). A sample mammogram with known response can be used to test the digitizer response. Other tests can verify/test other facets of the digitizer, such as the noise response, linearity, uniformity, reproducibility, and the like.

Referring now to FIG. 3F, the Maintenance screen can provide the user with graphic results, including display of the image that was just scanned, and historic results in the form of table and plots.

Another screen which can be employed by the CIS is referred to as a Log Screen, as shown in FIG. 3G. A tab/marker 18 notated as “Log”, located at the top of the screen in FIG. 3G, is an indication to the user that the user is operating within the log portion of the user interface.

Using the Log screen, the history of the case input can be displayed. Included in this display can be data related to the case identifier, scanning status, scanning time, QC results, CAD status, and the like.

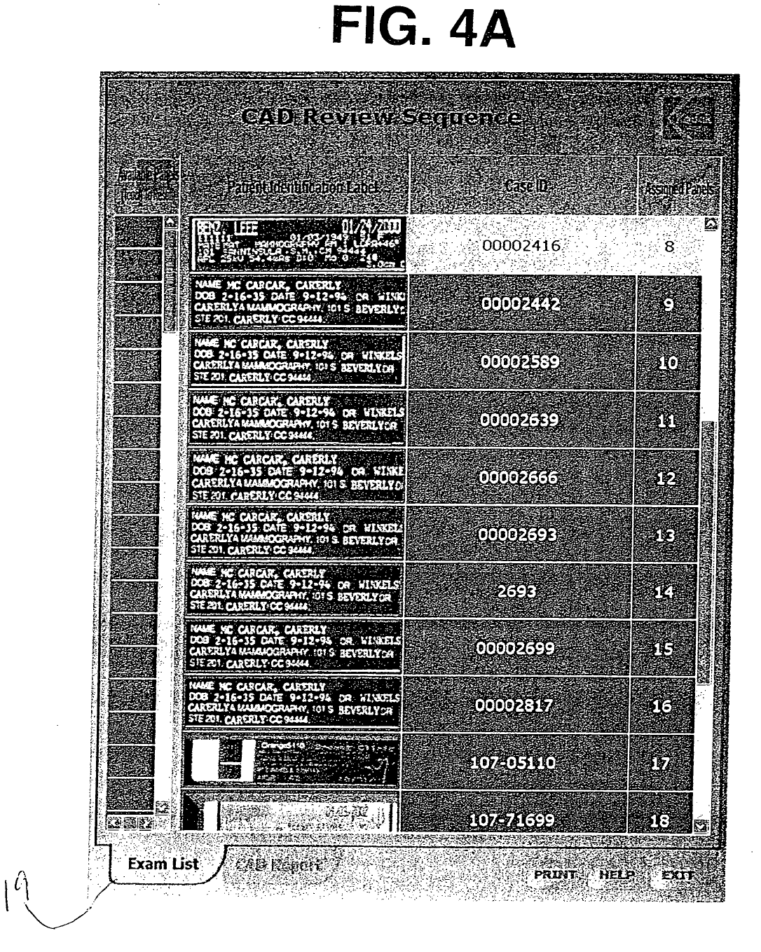

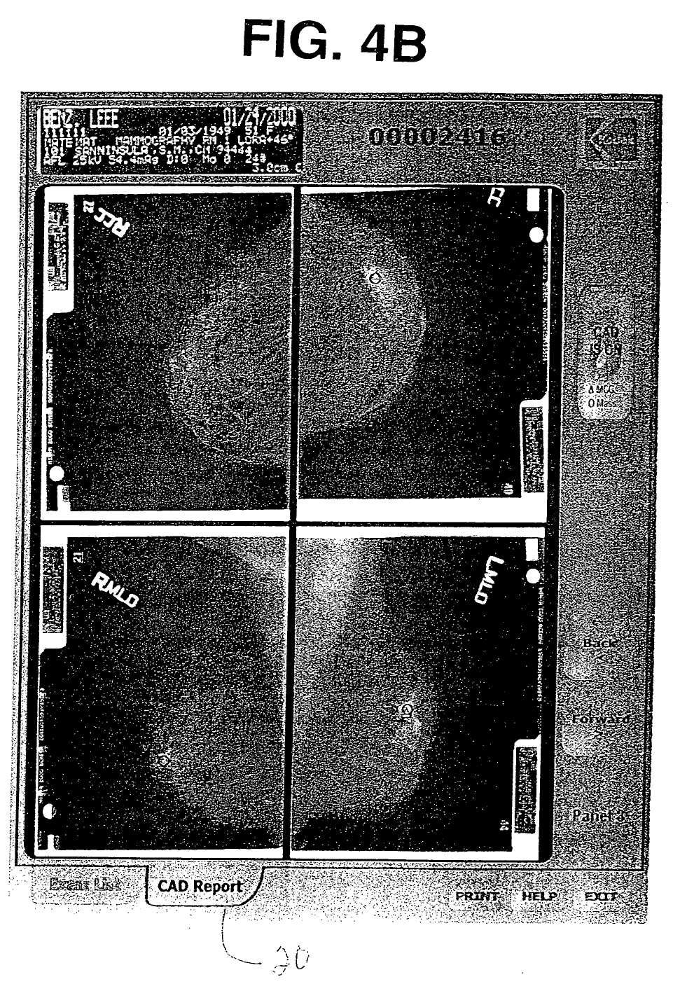

FIGS. 4A and 4B illustrate screens which can be employing in reporting the CAD results using the Report Station. More particularly, the Report Station (RS) allows the user to view digitized images with CAD marks.

Referring to FIG. 4A, this screen of the RS displays an exam list. A tab/marker 19 notated as “Exam List”, located at the bottom of the screen in FIG. 4A, is an indication to the user that the user is operating within the exam list portion of the Report Station.

This screen can show all available cases and allow the user to select a specific case by selecting/clicking on it. The available cases can be sorted in a variety of ways, for example: by digitizing sequence; by sorted case identification; by manual defined sequence; arbitrary by case identification; arbitrary by select patient identification label; and the like.

Another screen of the RS is shown in FIG. 4B. This screen shows the images of the case with (optionally) CAD marks. A tab/marker 20 notated as “CAD Report”, located at the bottom of the screen in FIG. 4B, is an indication to the user that the user is operating within the CAD Report portion of the Report Station.

This screen allows the user to select an image and enlarge it for easier viewing. Also, the user can move to the next or previous case with a single selection/click. The CAD marks (disposed on the image to indicate candidate locations of abnormalities) can be activated/deactivated (i.e., toggled on and off) with a single selection/click.

Other features which can be accessed using this screen can include: (I) patient label is extracted and enhanced for a radiologist to ensure the patient identification, (2) automatic image contrast justification for improved viewing of the breast tissue, (3) use of a hollow (transparent) geometry shape for the CAD marker so as to not block the image, (4) ability to modify the size/shape of the CAD marker, (5) user can select sensitivity and specificity operation point across a continuous range, (6) user can select sensitivity and specificity operation point by trading off number of CAD markers, (7) the number of images in a case is configurable, and (8) ability to support several hanging protocols.

The display of the CAD marks can also be obtained in a hard copy (i.e., printed) form. A screen display in the RS can be provided for this feature. The user could be allowed to configure the print options, including the ability to select the geometric shape of the CAD marker (including hollow/transparent), the use an automatic image contrast enhancement, and the ability to display a patient label, as well as provide the user with an the option of how to display the images (e.g., hanging protocol).

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

1. A user interface method for a computer aided detection system, the method comprising steps of:
accessing an image case, the image case comprising one or more digital images;
identifying a view orientation for each of the one or more digital images;
transmitting the image case to an algorithm server for processing of each of the one or more digital images to generate a computer aided detection report for the image case;
providing a report system adapted to organize a plurality of computer aided detection reports wherein each of the computer aided detection reports are selectable by an operator for viewing;
automatically transmitting the computer aided detection report to the report system;
allowing the operator to select the computer aided detection report for viewing; and
displaying the selected computer aided detection report on the display.

2. The method of claim 1, further comprising the step of, prior to automatically transmitting the image case to an algorithm server, automatically applying a quality control algorithm to each of the one or more digital images.

3. The method of claim 1, wherein a plurality of image cases are accessed, and each image case includes a barcode.

4. The method of claim 1, wherein a plurality of image cases are accessed, and the plurality of images cases are spaced by a separator sheet.

5. The method of claim 1, wherein the step of accessing the image case includes the step of digitizing the one or more digital images, and the method further comprises the step of displaying, on the display, a status of the digitization step.

6. The method of claim 1, wherein the step of accessing the image case includes the step of digitizing the image case, and the method further comprises the step of allowing the operator to prioritize the digitization of the image case.

7. The method of claim 1, further comprising the step of, prior to transmitting the image case to an algorithm server, confirming or rearranging the view orientation.

8. The method of claim 1, further comprising the step of allowing at least one of the following to be displayed on the display for viewing by the operator: (a) a digitization history of the image case, (b) an image case listing sorted by a case identifier, (c) an image case listing sorted by scanning status, (d) an image case listing sorted by a scan time, (e) an image case listing sorted by a quality control index, or (f) an image case listing sorted by processing status.

9. The method of claim 1, further comprising the step of allowing at least one of the following operations to be performed upon selection by the operator: (a) a maintenance operation, (b) a scanner calibration, (c) a scanner state verification, (d) provide a history listing, or (e) provide a maintenance recommendation.

10. A user interface method for a computer aided detection system, the method comprising steps of:
accessing a plurality of image cases, each image case comprising a plurality of digital images;
automatically transmitting the plurality of image cases to an algorithm server for processing of each of the plurality of image cases to generate a computer aided detection report for each of the plurality of image cases, wherein the transmittal sequence is predetermined by an operator selecting one of the following: by digitization sequence, by numerical order of the case identifier, or by numerical order of the patient identification label, or by manual defined sequence;
providing a report system adapted to organize a plurality of computer aided detection reports wherein each of the computer aided detection reports are selectable by an operator for viewing;
automatically transmitting the computer aided detection reports to the report system;
allowing the operator to select one of the computer aided detection reports for viewing; and
displaying the selected computer aided detection report on the display.

11. A user interface method for a computer aided detection system, the method comprising steps of:
accessing a plurality of image cases, each image case comprising a plurality of digital images;
automatically transmitting the plurality of image cases to an algorithm server for processing of each of the plurality of image cases to generate a computer aided detection report for each of the plurality of image cases;
providing a report system adapted to organize a plurality of computer aided detection reports wherein each of the computer aided detection reports are selectable by an operator for viewing;
automatically transmitting the computer aided detection reports to the report system;
allowing the operator to select one of the computer aided detection reports for viewing; and
displaying the selected computer aided detection report on the display, and the step of displaying the selected report is accomplished by the steps of:
determining the associated image case for the selected report;
determining a patient identification for the associated image case;
performing an automatic image contrast justification for each of the plurality of digital images of the associated image case; and
determining a CAD marker size.
